(19) United States
(12) Patent Application Publication
(10) Pub. No.: US 2026/0331798 A1
(43) Pub. Date: Oct. 22, 2026

(54) ELECTRICAL CONNECTOR WITH IMPROVED MOUNTING CLIPS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: YUNG-CHIH HUNG, New Taipei (TW)

(21) Appl. No.: 19/649,608

(22) Filed: Apr. 16, 2026

(30) Foreign Application Priority Data
Apr. 17, 2025 (CN) 202510486941.9

(51) Int. Cl. H01R 12/71; H01R 12/70; H01R 13/621; H01R 13/627

(52) U.S. Cl. CPC H01R 12/71; H01R 12/7088; H01R 13/621; H01R 13/6275

(57) ABSTRACT

An electrical connector for mounting on a circuit board includes: an insulative housing including a mounting portion, the mounting portion having opposite top and bottom surfaces and a vertical surface connecting the bottom and top surfaces; a mounting hole defined in the mounting portion and extending through the bottom surface, the top surface, and the vertical surface to form a vertical opening; plural conductive terminals retained in the housing; and a mounting clip including a fixing portion fixed to the mounting portion, a board locking portion configured to secure the connector to the circuit board, and a blocking portion attached to the vertical surface and covering the vertical opening.

### BACKGROUND OF THE INVENTION

### Field of the Invention

The present invention relates to an electrical connector.

### Description of Related Arts

U.S. Pat. No. 7,059,919 discloses a power connector, in which mounting brackets are provided on both sides of a housing thereof. Each mounting bracket is provided with a mounting aperture for a mounting clip. In some embodiments, the mounting aperture extends only in a vertical direction, while in other embodiments, the mounting aperture extends in a vertical direction and a rearward direction. U.S. Pat. No. 7,727,001 discloses a power connector, wherein each mounting structure has a fastener passage and a latch cavity extending parallel to the fastener passage. The fastener passage extends laterally to reduce the longitudinal size of the connector. However, this structure may result in inconvenience during fastener installation.

### SUMMARY OF THE INVENTION

An object of the present invention is to provide an electrical connector configured to improve the installation of a mounting clip.

In order to achieve above-mentioned object, an electrical connector for mounting on a circuit board, comprises: an insulative housing comprising a mounting portion with a bottom surface facing the circuit board, a top surface opposite the bottom surface, and a vertical surface connecting with the bottom surface and the top surface, the mounting portion having a mounting hole extending through the bottom surface and the top surface, the mounting hole further extending through the vertical surface to form a vertical opening; a plurality of conductive terminals retained in the insulative housing; a mounting clip comprising a fixing portion fixed to the mounting portion and a board locking portion configured to secure to the circuit board. The mounting clip further comprises a blocking portion attached to the vertical surface and covering the vertical opening.

Other objects, advantages and novel features of the present invention will become more apparent from the following detailed description of the present embodiment when taken in conjunction with the accompanying drawings.

### BRIEF DESCRIPTION OF DRAWINGS

FIG. 1 is a perspective view of an electrical connector according to a first embodiment of the present invention;

FIG. 2 is a top view of the electrical connector of FIG. 1;

FIG. 3 is a side view of the electrical connector of FIG. 1;

FIG. 4 is a perspective view of the right half of the electrical connector of FIG. 1, with the terminals removed;

FIG. 5 is a perspective view of FIG. 4 from another angle;

FIG. 6 is a bottom view of FIG. 5;

FIG. 7 is an exploded perspective view of FIG. 4;

FIG. 8 is an exploded perspective view of FIG. 7 from another angle;

FIG. 9 is a perspective view of the mounting clip in FIG. 7;

FIG. 10 is a perspective view of an electrical connector according to a second embodiment of the present invention mounted on a circuit board, with the terminals removed;

FIG. 11 is a perspective view showing the electrical connector and the circuit board separated from each other in FIG. 10;

FIG. 12 is an exploded perspective view of the electrical connector in FIG. 11; and

FIG. 13 is a sectional schematic view showing the process of installing the locking member into the mounting hole.

### DETAILED DESCRIPTION OF THE DRAWINGS

Reference will now be made in detail to the preferred embodiments of the present invention.

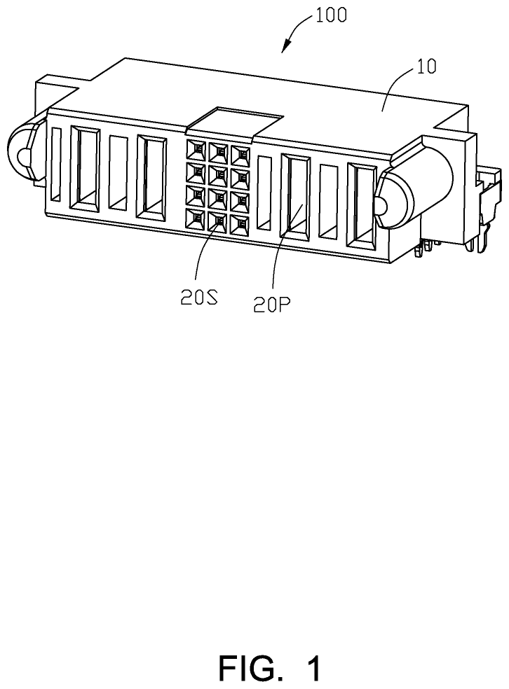

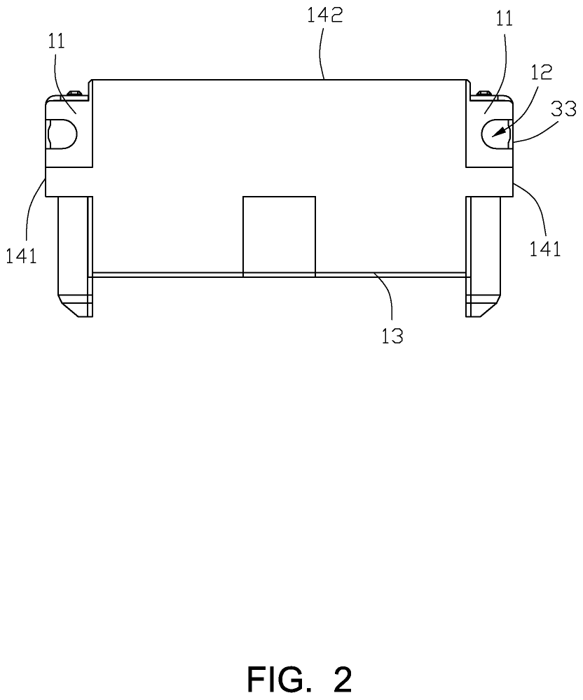

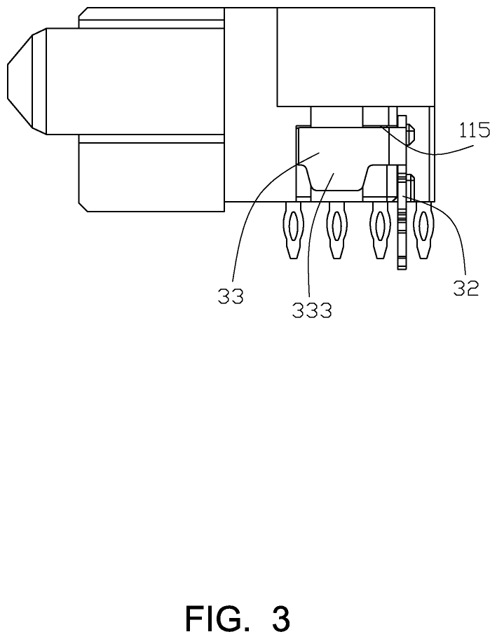

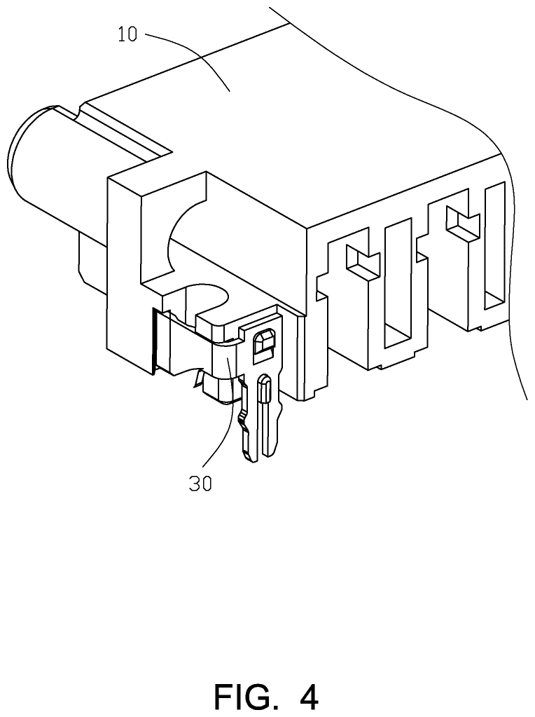

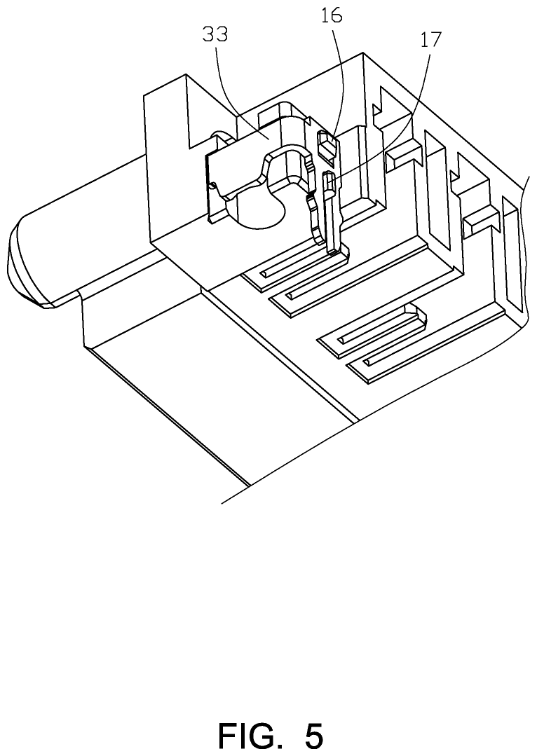

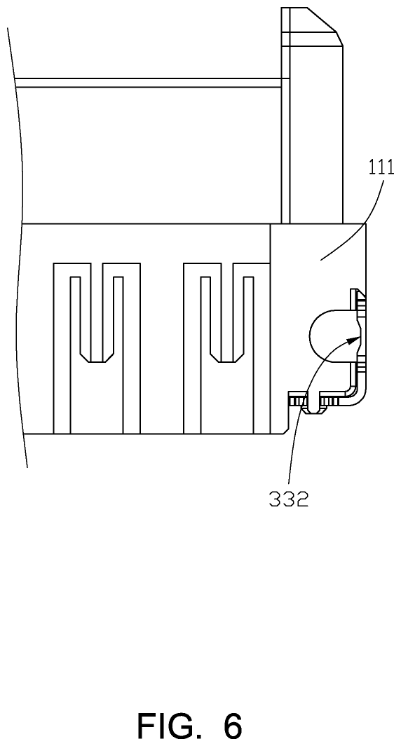

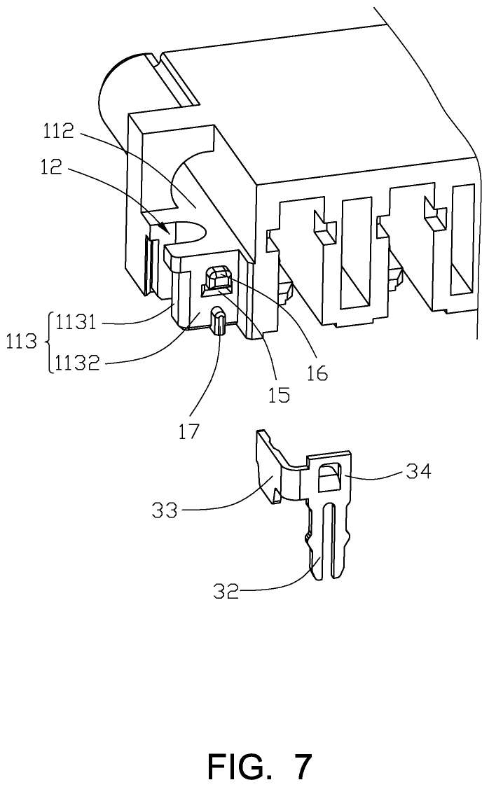

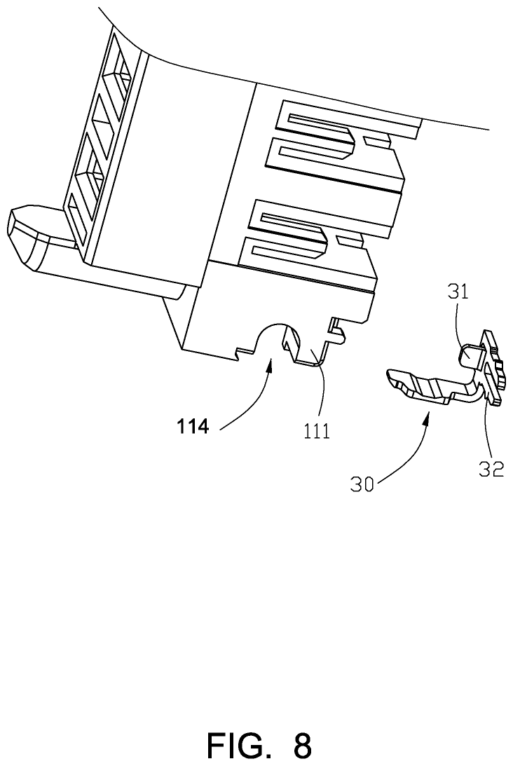

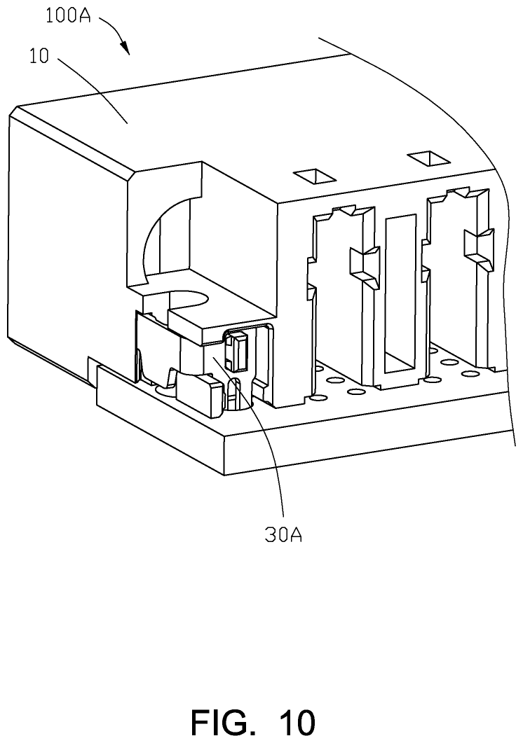

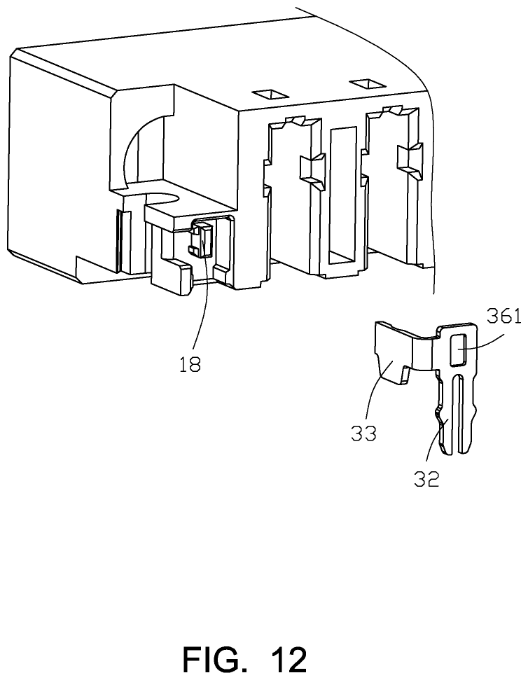

Referring to FIGS. 1-9, a first embodiment of an electrical connector 100 of the present invention is illustrated. Referring to FIGS. 10-13, a second embodiment of an electrical connector 100A is illustrated. The two embodiments have generally similar structures, with the main difference of the mounting clip 30, 30A. As shown in FIGS. 1 and 10-13, the electrical connector 100/100A is mounted on a circuit board 900 and includes an insulative housing 10 and a plurality of conductive terminals. In a specific embodiment, the conductive terminals include at least one power terminal 20P and at least one signal terminals 20S. The power terminals are relatively large in size and mainly used for transmitting high current, while the signal terminals are generally pin-shaped and used for detection or device management functions. Since some of the conductive terminals are relatively large, a greater insertion and withdrawal force is required. Therefore, a mounting clip 30/30A and a locking member 40 are provided to stably secure the electrical connector on the circuit board 900. The main improvement of the present invention lies in optimizing the structure of the mounting clip to improve the assembly of the electrical connector on the circuit board.

Referring to FIGS. 1-9, the electrical connector 100 includes an insulative housing 10, a plurality of conductive terminals, and at least one mounting clip 30. The insulative housing includes at least one mounting portion 11, the mounting portion 11 has a bottom surface 111 facing the circuit board 900, a top surface 112 opposite the bottom surface, and a vertical surface 113 connecting the bottom and top surfaces. The mounting portion 11 has a mounting hole 12 extending through the bottom surface 111, the top surface 112, and the vertical surface 113 to form a vertical opening 114. The mounting clip 30 is made of a metal plate and includes a fixing portion 31, a board locking portion 32, and a blocking portion 33. The fixing portion 31 is fixed to the mounting portion 11, the board locking portion 32 is configured to secure the connector to the circuit board 900, and the blocking portion 33 is attached to the vertical surface 113 and covers the vertical opening 114. The blocking portion 33 further has an extension portion 333 at a lower edge thereof. In this embodiment, the insulative housing has two mounting portions 11 at opposite sides thereof in a first direction, and two mounting clips 30 are retained on the mounting portions 11 respectively.

Referring to FIGS. 10-13, the mounting clip 30A of the second embodiment has a similar structure and includes a blocking portion 32 and a board locking portion 33. The mounting clip 30A has a fixing opening 361, and the mounting portion 11 has a protruding fixing block 18. The fixing opening 361 is fixed to the fixing block 18 by interference fit, thereby forming a fixed relationship. The fixing opening 361 constitutes the fixing portion.

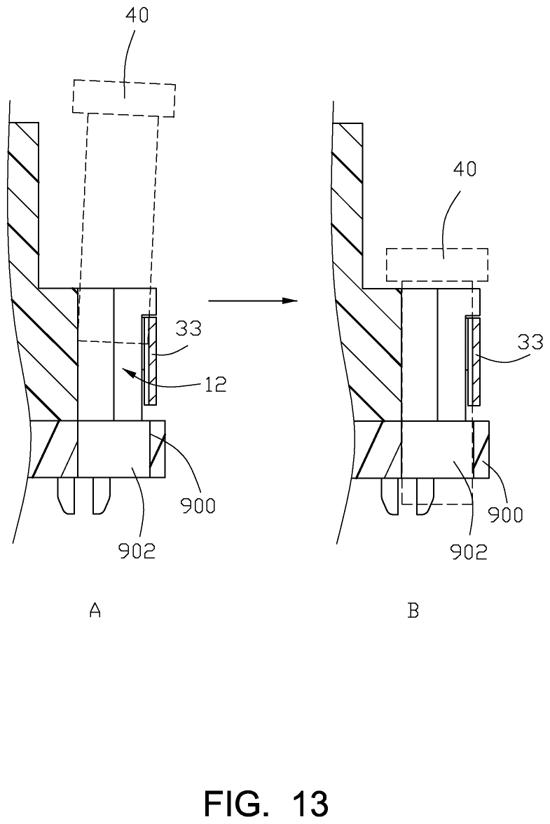

Referring to FIG. 13, the blocking portion 33 covers the vertical opening 114 of the mounting hole 12. When the locking member 40 is inserted into the mounting hole 12 from the top surface 112, the blocking portion 33 prevents the locking member 40 from tilting outward and guides the locking member 40into pre-determined position, even if there is a tendency for the locking member 40 to tilt. Thus, the blocking portion 33 can prevent the locking member 40 from tilting during installation into the mounting hole 12. The blocking portion 33, made of a metal plate, has a certain elasticity and will not damage the locking member 40. The extension portion 333 is elongated in the vertical direction, thereby helping to further restrict the locking member 40. In this embodiment, the locking member is a bolt structure.

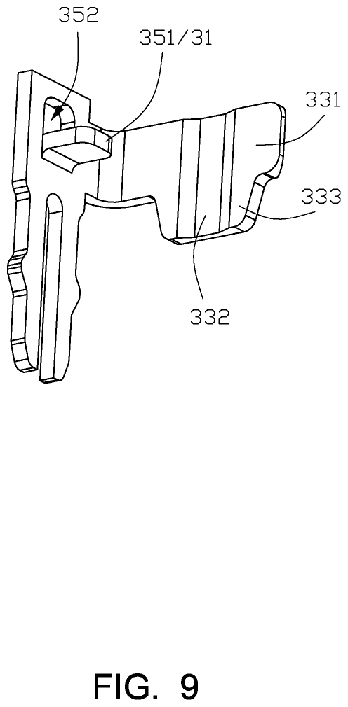

Further, as shown in FIG. 9, the blocking portion 33 includes an inner surface 331 facing the mounting hole 12 and an opposite outer surface. The inner surface 331 has a recessed portion 332 at an inside thereof, the recessed portion 332 extends vertically through the blocking portion 33. The bolt is generally cylindrical, and the recessed portion 332 can match a part of the surface of the locking member 40, thereby better positioning and guiding the installation of the locking member.

In this embodiment, the vertical surface 113 of the mounting portion 11 includes a first vertical surface 1131 and a second vertical surface 1132 perpendicular to each other, and the vertical opening 114 is disposed on the first vertical surface 1131. In this embodiment, the electrical connector 100 is an angled connector, and the insulative housing 10 has a forwardly extending mating portion 13, the mating direction of the mating portion 13 is parallel to the circuit board 900. The mounting holes 12 extend through two opposite side surfaces 141 of the insulative housing, the first vertical surface 1131 is located on the side surface 141, and the second vertical surface 1132 is a rear surface 142 opposite to the mating portion 13.

In this embodiment, the mounting portion 11 has a fixing slot 15 extending through the second vertical surface 1132, and the fixing portion 31 is inserted and fixed in the fixing slot 15. It can be seen that the fixing slot 15 is recessed forward from the rear surface 142 and extends in the horizontal direction, while the mounting hole 12 extends in the vertical direction, that is, the fixing slot 15 and the mounting hole 12 are perpendicular to each other.

Furthermore, the mounting clip 30 includes a base portion 34, the board locking portion 32 extends downwardly from the base portion 34. The base portion is stamped to form a tab 351 and an opening 352, and the tab 351 bends forward to form the fixing portion 31. The mounting clip 30 is assembled forwards into the mounting portion 11 from the rear surface 142, with the tab 351 being inserted into the fixing slot 15, thereby fixing the mounting clip 30 to the mounting portion 11. The blocking portion 33 bends from one side edge of the base portion 34 and is disposed vertically. The vertical blocking portion 33 is attached to the first vertical surface 1131. Therefore, the increased size of the connector is minimal.

Furthermore, the second vertical surface 1132 of the mounting portion 11 has a protruding bump 16 passing through and fixed in the opening 352. The board locking portion 32 is formed as a bifurcated structure, and the second vertical surface 1132 of the mounting portion has a vertical rib 18 clamped between the two prongs of the bifurcated structure, thereby further securing the mounting clip 30. The mounting portion 12 has a downwardly facing limiting surface 115, the blocking portion 33 abuts forwardly against the insulative housing and upwardly against the limiting surface 115. Thus, the mounting clip 30 is restricted upwardly by the limiting surface 115 and downwardly by the vertical rib 18.

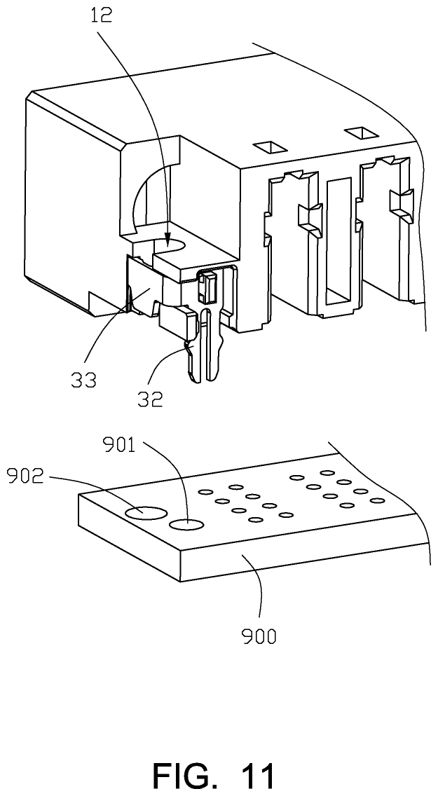

Referring to FIGS. 11-13, the circuit board 900 has a first hole 901 and a second hole 902. After the electrical connector is mounted to the circuit board 900, the soldering legs of the terminals are inserted into the terminal holes, and the board locking portion 32 is inserted into the first hole 901. Furthermore, the locking member 40 is inserted into the mounting hole 12, a nut is screwed onto the end of the locking member 40, and the head of the locking member abuts against the top surface 112 of the mounting portion, thereby further securing the electrical connector to the circuit board.

In other embodiments, the mounting hole 12 may be disposed adjacent to the rear surface 142 of the insulative housing, with the vertical surface opening 114 located on the rear surface 142, the first vertical surface being the rear surface, and the second vertical surface being a side surface perpendicular to the rear surface.

The mounting clip 30 is made from a metal plate and includes a rear plate and a side plate bending forwards from the rear plate, and the board locking portion 32 extending downwards from the rear plate. The rear plate and the side plate are located uprightly. The side plate is attached to the mounting portion and cover the vertical opening to commonly form the mounting hole. The rear plate is constructed as the base portion. The horizontal tab 31 is punched and bend forward to be inserted in the fixing slot in the mounting portion. The bump extends rearwards and is inserted into the opening remained when the horizontal tab 31 is punched

In other embodiments, the electrical connector may be a vertical type, with the mating portion extending upwardly and the mating direction being perpendicular to the circuit board. It can be understood that in the above embodiments, the surface of the insulative housing seated on the circuit board is the bottom surface, and the opposite surface is the top surface.

However, the disclosure is illustrative only, changes may be made in detail, especially in matter of shape, size, and arrangement of parts within the principles of the invention.

1. An electrical connector for mounting on a circuit board, comprising:
an insulative housing comprising a mounting portion with a bottom surface facing the circuit board, a top surface opposite the bottom surface, and a vertical surface connecting with the bottom surface and the top surface, the mounting portion having a mounting hole extending through the bottom surface and the top surface, the mounting hole further extending through the vertical surface to form a vertical opening;
a plurality of conductive terminals retained in the insulative housing; and
a mounting clip comprising a fixing portion fixed to the mounting portion and a board locking portion configured to secure to the circuit board;
wherein the mounting clip further comprising a blocking portion attached to the vertical surface, and the blocking portion covers the vertical opening.

2. The electrical connector as claimed in claim 1, wherein the blocking portion has an inner surface facing the mounting hole, and the inner surface has a recessed portion extending vertically.

3. The electrical connector as claimed in claim 1, wherein the vertical surface of the mounting portion has a first vertical surface and a second vertical surface perpendicular to each other, the vertical opening is disposed on the first vertical surface, the mounting portion has a fixing slot extending through the second vertical surface, and the fixing portion is inserted and fixed in the fixing slot.

4. The electrical connector as claimed in claim 3, wherein the mounting clip comprises a base portion, the board locking portion extends downwardly from the base portion, the base portion is stamped to form a tab and an opening, and the tab bends forward to form the fixing portion.

5. The electrical connector as claimed in claim 4, wherein the blocking portion bends from one side edge of the base portion and is configured as a vertical structure.

6. The electrical connector as claimed in claim 4, wherein the second vertical surface of the mounting portion has a bump fixed in the opening.

7. The electrical connector as claimed in claim 4, wherein the second vertical surface of the mounting portion has a vertical rib, the board locking portion is configured as a bifurcated structure, and the vertical rib is clamped in the bifurcated structure.

8. The electrical connector as claimed in claim 1, wherein the insulative housing comprises a mating portion extending forward, the second vertical surface is a rear surface opposite to the mating portion, and the first vertical surface is a side surface.

9. The electrical connector as claimed in claim 1, wherein the blocking portion is configured as a vertical structure.

10. The electrical connector as claimed in claim 9, wherein the mounting portion has a limiting surface facing downwardly, and the blocking portion abuts against the insulative housing forwardly and against the limiting surface upwardly.

11. An electrical connector assembly comprising:
a circuit board having two first holes and two second holes; and
an electrical connector comprising:
an insulative housing comprising two mounting portions at opposite side surfaces thereof in a first direction, each mounting portion having a bottom surface facing the circuit board, a top surface opposite the bottom surface, a vertical surface connecting the top and bottom surfaces, and a mounting hole extending through the bottom surface, the top surface, and the vertical surface;
a plurality of conductive terminals retained in the insulative housing; and
two mounting clips fixed to corresponding mounting portions respectively, each of the mounting clips comprising a board locking portion inserted and fixed to the first hole of the circuit board; and
two locking members passing through corresponding mounting holes and being inserted in corresponding second holes of the circuit board;
wherein each of the mounting hole opens outwards in the first direction to form a vertical opening, the mounting clip comprises a block portion covering the vertical opening, the locking member is inserted along an inner surface of the block portion into the mounting hole.

12. The electrical connector assembly as claimed in claim 11, wherein the inner surface of the block portion has a recess portion corresponding to a shape of the locking member.

13. An electrical connector comprising:
an insulative housing comprising a mating portion and two mounting portions on opposite sides of the mating portion in a first direction, each of the mounting portions having a mounting hole opening outwards in the first direction to form a vertical opening;
a plurality of conductive terminals located in the mating portions; and
two mounting clips fixed to the mounting portions respectively;
wherein each of the mounting clips comprises a rear plate, a side plate bending forwards from the rear plate, and a board locking portion extending downwards from the rear plate, and the side plate is attached to the mounting portion and covers the vertical opening to commonly form the mounting hole.

14. The electrical connector as claimed in claim 13, wherein the rear plate and the side plate are located uprightly, and mounting clip comprises a horizontal tab inserted in a fixing slot of the mounting portion.

15. The electrical connector as claimed in claim 14, wherein the mounting portion has a bump extending rearwards and inserted into an opening of the rear plate.
